(19) United States
(12) Patent Application Publication
(10) Pub. No.: US 2007/0174251 A1
(43) Pub. Date: Jul. 26, 2007

(54) SYSTEM AND METHOD FOR ANALYZING COMMANDS FOR SEARCHING DATA

(75) Inventors: LIANG-PU LI, Shenzhen (CN); CHUNG-I LEE, Tu-Cheng (TW); CHIEN-FA YEH, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/556,180

(22) Filed: Nov. 3, 2006

(30) Foreign Application Priority Data
Jan. 12, 2006 (CN) 200610032908.6

(51) Int. Cl. G06F 17/30

(52) U.S. Cl. 707/3

(57) ABSTRACT

The present invention provides a method for analyzing commands for searching data. The method includes the steps of: creating a command queue; reading commands for searching relevant data; converting formats of the commands into the extensible markup language format; defining attributes of the commands; adding the commands into the command queue according to the attributes; executing the commands in the command queue to search the relevant data on Web sites; determining whether any relevant data have been found on the Web sites; returning a list of uniform resource locator (URL) addresses if the relevant data have been found on the Web sites, wherein each URL address links a web page comprising the relevant data; creating sub-commands based on the URL addresses for downloading the web pages by analyzing the list of URL addresses; converting formats of the sub-commands into the extensible markup language format; and executing the sub-commands to download the Web pages comprising the relevant data according to the URL addresses. A related system is also disclosed.

### BACKGROUND OF THE INVENTION

1. Field of the Invention

The present invention relates to systems and methods for searching data, especially to systems and methods for analyzing commands for searching data.

2. Description of Related Art

In recent years, with the quantity of network data continually increasing, more and more search engines are provided for users to search data through the Internet, or other kinds of network. Many search engines do not provide a system or a method for analyzing commands for searching data effectively. For example, if the user inputs a command to search and download American patents whose titles include “virtual machine”, the search engines may return three hundred patents. However, afterwards, the user will have to download all the patents through repetitive manual operations with the search engines (i.e., to browse through each returned links and save the corresponding data), these search engines cannot analyze the command to multiple new commands for downloading all the patents seriatim and automatically. Furthermore, some search engines require the user to input commands for searching data in a predefined syntax, which would require the user to know the predefined syntax well.

Moreover, some search engines are programmed and compiled by using a C++ programming language or a java™ programming language. Generally, functions of such search engines are simplex, and lack configurable abilities. For example, when the user needs to search data at different Web sites that were developed by different programming languages, the search engines may not be adapted for some special Web sites as their programming languages are different. Then, the search engines have to be reprogrammed, so as to meet the special Web sites. Thus, much time and manpower are wasted in reprogramming or re-compiling the search engines.

What is needed, therefore, is a system and method for analyzing commands for searching data that can analyze commands inputted by the users for searching the relevant data, and convert formats of the commands to the extensible markup language format, which is extensible to be adapted for different Web sites without complex operations. The system and method do not require the users to master a special skill on how to input their commands.

### SUMMARY OF THE INVENTION

A system for analyzing commands for searching data is provided. The system includes a command reading module, a format converting module, a command queue controlling module, and a command executing module. The command reading module is configured for creating a command queue, and for reading commands for searching relevant data. The format converting module is configured for converting formats of the commands into the extensible markup language format. The command queue controlling module is configured for defining attributes of the commands, and for adding the commands into the command queue according to the attributes. The command executing module is configured for executing the commands in the command queue to search the relevant data on Web sites, for returning a list of uniform resource locator (URL) addresses, and for analyzing the list of URL addresses to create sub-commands based on the URL addresses for downloading web pages comprising the relevant data.

Furthermore, a method for analyzing commands for searching data is provided. The method includes the steps of: creating a command queue; reading commands for searching relevant data; converting formats of the commands into the extensible markup language format; defining attributes of the commands; adding the commands into the command queue according to the attributes; executing the commands in the command queue to search the relevant data on Web sites; determining whether any relevant data have been found on the Web sites; returning a list of uniform resource locator (URL) addresses if the relevant data have been found on the Web sites, wherein each URL address links a web page comprising the relevant data; creating sub-commands based on the URL addresses for downloading the web pages by analyzing the list of URL addresses; converting formats of the sub-commands into the extensible markup language format; and executing the sub-commands to download the Web pages comprising the relevant data according to the URL addresses.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of an application environment of a system for analyzing commands for searching data in accordance with a preferred embodiment;

FIG. 2 is a schematic diagram of main software function modules of the client computer of FIG. 1;

FIG. 3 is a schematic diagram of main software function modules of the system of FIG. 1; and

FIG. 4 is a flowchart of a method for analyzing commands for searching data in accordance with a preferred embodiment.

### DETAILED DESCRIPTION OF THE INVENTION

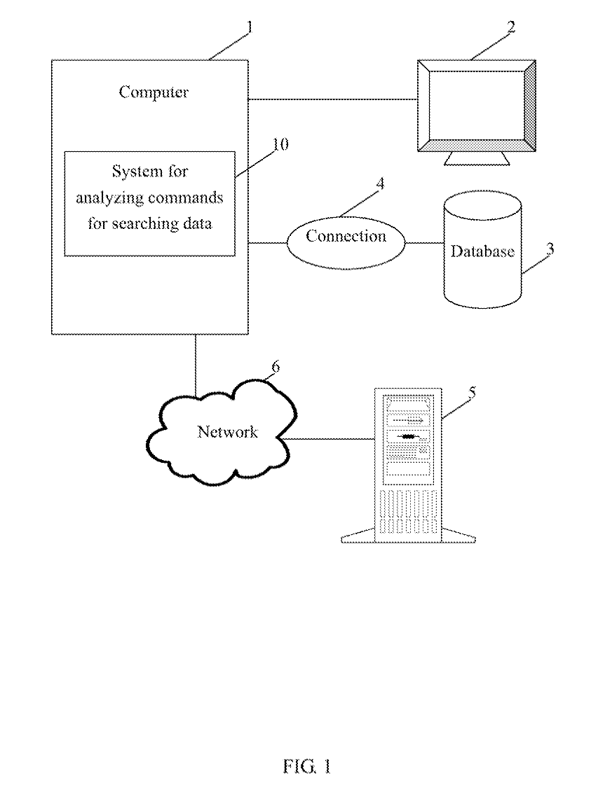

FIG. 1 is a schematic diagram of an application environment of a system for analyzing commands for searching data in accordance with a preferred embodiment. The system for analyzing commands for searching data (hereinafter, “the system”) 10 is configured in a computer 1 that is digitally connected with at least a client computer 2. The client computer 2 may be a common computer device such as a personal computer, a laptop, a portable handheld device, a mobile phone, or other suitable electronic communication terminals. The client computer 2 provides an interactive user interface for inputting commands. The computer 1 is further electronically connected with a database 3 via a connection 4. The database 3 is configured (i.e., structured and arranged) for storing various kinds of data, such as patent data and commercial data, etc. The connection 4 is typically a database connectivity, such as an open database connectivity (ODBC) or a Java database connectivity (JDBC).

The computer 1 communicates with at least one application server 5 (only one shown) via a network 6. The network 6 may be an intranet, the Internet, or any other suitable type of communication links. The application server 5 is configured for linking to Web servers (not shown) that host different Web sites therein via the network 6. The Web sites are sites (locations) on the World Wide Web (WWW), and are entire collections of Web pages and other data (such as images, sounds, and video files, etc.). The Web sites may be specified Web sites, such as patent data Web sites.

The system 10 is configured for receiving and executing the commands inputted by the users on the client computer 2, for searching relevant data in the database 3 through the connection 4 or on the Web sites through linking the application server 5 to the Web servers, and for returning a command result (if exists) to the client computer 2. The command result may be a list of database locations that contains the relevant data, or a list of uniform resource locator (URL) addresses that corresponds to the Web page(s) containing the relevant data. If the command result is the list of URL addresses, the system 10 is further configured for analyzing the list of URL addresses to create sub-commands for downloading the Web pages containing the relevant data.

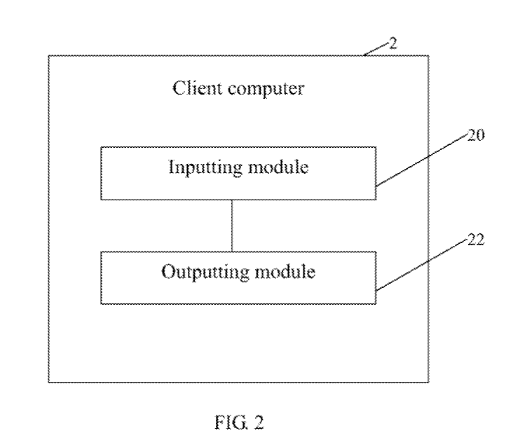

FIG. 2 is a schematic diagram of main software function modules of the client computer 2. The client computer 2 includes an inputting module 20 and an outputting module 22. The inputting module 20 is configured for providing an interface for the users to input the commands, and for transmitting the commands inputted to the system 10.

If the system 10 has acquired the command results, the system 10 returns the command results to the client computer 2, and the outputting module 22 outputs the command results to the users through a monitor, a printer, or other peripheral equipments (not shown).

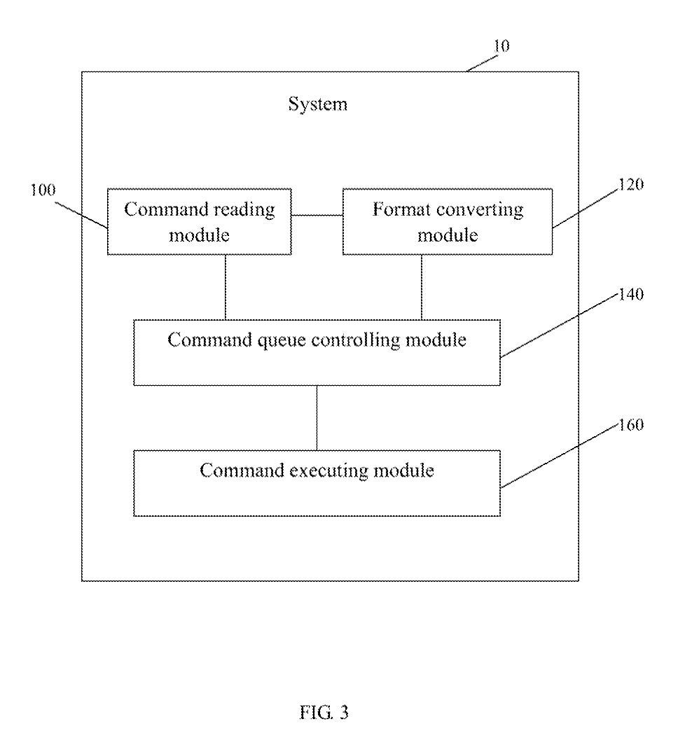

FIG. 3 is a schematic diagram of main software function modules of the system 10. The system 10 includes a command reading module 100, a format converting module 120, a command queue controlling module 140, and a command executing module 160.

The command reading module 100 is configured for creating/initializing a command queue that is empty, and for reading the commands transmitted from the client computer 2. The command reading module 100 is also configured for creating a queue handle for the command queue, the queue handle is configured for uniquely identifying the command queue.

The format converting module 120 is configured for converting syntax/formats of the commands into the extensible markup language (XML) format. XML format contains a series of elements and attributes. XML allows structuring data with user-defined tags. Basic requirements of the XML format may include: an XML declaration at the start of a document, explicit nesting of tags, and a root element. Furthermore, the elements are defined according to document type definition (DTD) documents or schema documents. For example, an XML document includes following XML sentences:

<book>
<title>action script: the definitive guide</title>
<author salutation=“mr.”>colin moock</author>
<publisher>o'reilly</publisher>
</book>

As shown in the above XML sentences, compositive elements of the XML document are “book”, “title”, “author”, and “publisher”; and an attribute of the XML document is “salutation”.

The command queue controlling module 140 is configured for defining attributes of the commands after converting the formats of the commands. The orders of the commands in the command queue depend on the attributes of the commands. The command queue controlling module 140 is further configured for adding the commands into the command queue according to the attributes. For example, the command queue controlling module 140 defines an attribute of the command for searching the database 3, and the attribute defined restricts that the command should be added to a front of the command queue. Corresponding XML sentences include:

<database queue=“top”>
<sql>insert into test1(c1,n1) values(?,?)</sql>
<bind>
<variable type=“string”>hello</variable>
<variable type=“int”>5</variable>
</bind>
<bind>
<variable>world</variable>
<variable type=“int”>4</variable>
</bind>
</database>

The command executing module 160 is configured for selecting the commands in the command queue, for executing the commands to search the relevant data in the database 3 or on the Web sites, for deleting the commands that have been executed from the command queue, and for returning the command result to the client computer 2. The Web sites may be specified. The command result may be the list of database locations of the relevant data, or the list of uniform resource locator (URL) addresses of the Web pages including the relevant data.

If the command result is the list of URL addresses, the command executing module 160 is also configured for creating sub-commands. The command executing module 160 analyzes the list of URL addresses and creates a sub-command for each URL address listed on the list of URL addresses. The sub-commands are configured for downloading the Web pages corresponding to the URL address. The format converting module 120 is also configured for converting formats of the sub-commands into the XML format, then, the command executing module 160 is further configured for executing the sub-commands to download the Web pages comprising the relevant data according to the URL addresses.

Moreover, the format converting module 120 is configured for converting formats (hypertext markup language format) of the Web pages to the XML format, and the command executing module 160 is configured for returning the Web pages downloaded to the client computer 2, and for storing the Web pages download into the database 3.

For example, the user inputs a command through the inputting module 20 if he/she needs to search United State patents whose titles include “connector”, the system 10 connects the application server 5 to search the patents on corresponding specified Web sites whose URL address is “http://www.uspto.gov”, the command executing module 160 returns the list of URL addresses that includes fifty URL addresses corresponding to fifty patents by executing the command, then the command executing module 160 creates fifty sub-commands by analyzing the list of URL addresses. The fifty sub-commands are used for downloading the fifty patents according to the URL addresses.

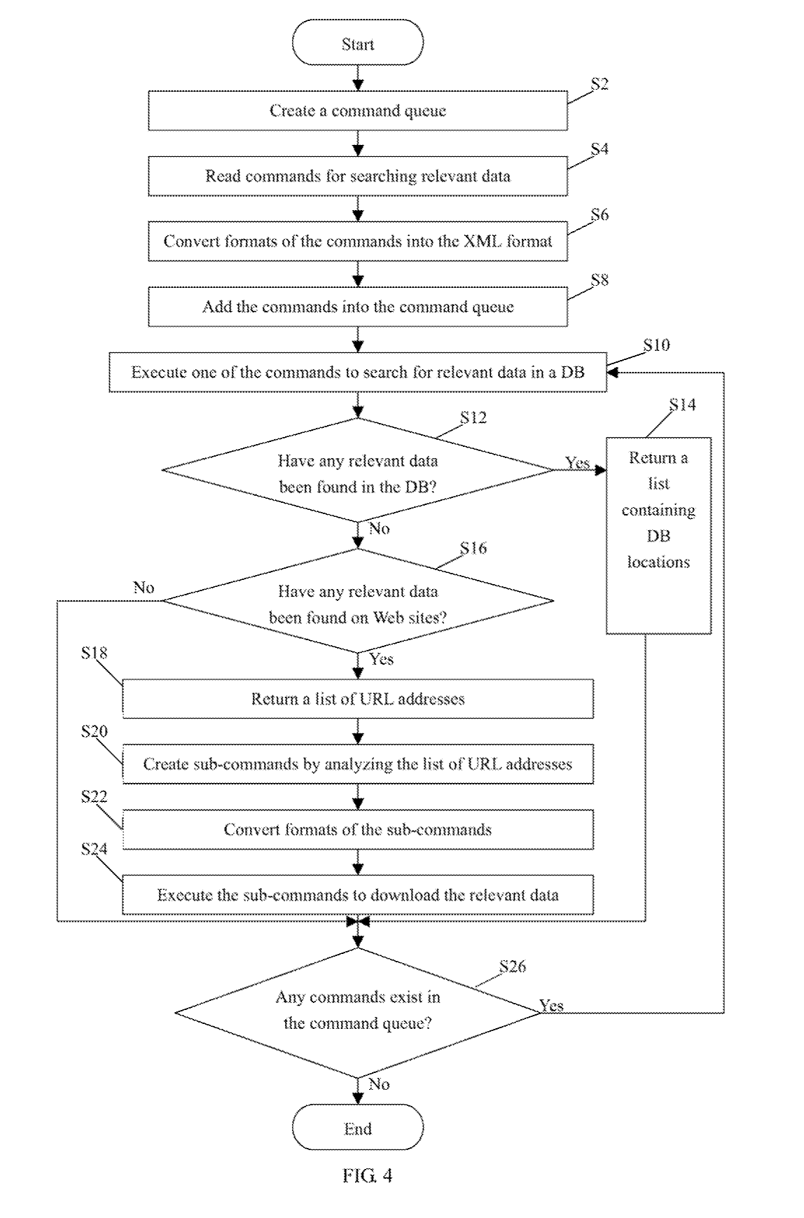

FIG. 4 is a flowchart of a method for analyzing commands for searching data. In step S2, the command reading module 100 creates the command queue that is empty, and creates the queue handle for the command queue.

In step S4, commands are inputted through the inputting module 20 on the client computer 2, the inputting module 20 transmits the commands to the system 10 configured in the computer 1, and the command reading module 100 reads the commands.

In step S6, the format converting module 120 converts the formats of the commands into the XML format. In step S8, the command queue controlling module 140 defines the attributes of the commands, and adds the commands into the command queue according to the attributes.

In step S10, the command executing module 160 executes one of the commands in the command queue for searching the relevant data in the database 3. In step S12, the command executing module 160 determines whether any relevant data have been found in the database 3. If the relevant data have been found in the database 3, in step S14, the command executing module 160 returns the list of database locations of the relevant data if the relevant data have been found in the database, and deletes the command executed from the command queue correspondingly. Then the procedure directly goes to step S26.

If no relevant data have been found in the database 3, in step S16, the command executing module 160 searches the relevant data on the Web sites, and determines whether any relevant data have been found on the Web sites. If the relevant data have been found on the Web sites, in step S18, the command executing module 160 returns the list of URL addresses, and deletes the command executed from the command queue. Each URL address links a Web page including the relevant data.

In step S20, the command executing module 160 creates the sub-commands based on the URL addresses for downloading the web pages by analyzing the list of URL addresses. In step S22, the format converting module 120 converts formats of the sub-commands into the XML format. In step S24, the command executing module 160 executes the sub-commands to download the Web pages containing the relevant data according to the URL addresses, the downloaded Web pages are returned to the client computer 2, and are stored into the database 3. In step S26, the command executing module 160 determines whether any commands exist in the command queue. If one or more commands exist in the command queue, the procedure returns to step S10; otherwise, if no commands exists in the command queue, the procedure ends.

In step S16, if no relevant data have been found on the Web sites, the procedure directly goes to step S26.

It should be emphasized that the above-described embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for analyzing commands for searching data, comprising:
a command reading module configured for creating a command queue, and for reading commands for searching relevant data;
a format converting module configured for converting formats of the commands into the extensible markup language format;
a command queue controlling module configured for defining attributes of the commands, and for adding the commands into the command queue according to the attributes; and
a command executing module configured for executing the commands in the command queue to search the relevant data on Web sites, for returning a list of uniform resource locator (URL) addresses, and for analyzing the list of URL addresses to create sub-commands based on the URL addresses for downloading web pages comprising the relevant data.

2. The system as claimed in claim 1, wherein the format converting module is further configured for converting formats of the sub-commands into the extensible markup language format.

3. The system as claimed in claim 2, wherein the command executing module is configured for executing the sub-commands to download the Web pages comprising the relevant data according to the URL addresses.

4. The system as claimed in claim 1, wherein the command reading module is further configured for creating a queue handle for the command queue.

5. The system as claimed in claim 1, wherein the command executing module is further configured for deleting the commands that have been executed from the command queue.

6. The system as claimed in claim 1, wherein the command executing module is further configured for searching the relevant data in a database.

7. The system as claimed in claim 6, wherein the command executing module is further configured for returning a list of database locations of the relevant data.

8. The system as claimed in claim 1, wherein the attributes of the commands restrict orders of the commands in the command queue.

9. A method for analyzing commands for searching data, comprising the steps of:
creating a command queue;
reading commands for searching relevant data;
converting formats of the commands into the extensible markup language format;
defining attributes of the commands;
adding the commands into the command queue according to the attributes;
executing the commands in the command queue to search the relevant data on Web sites;
determining whether any relevant data have been found on the Web sites;
returning a list of uniform resource locator (URL) addresses if the relevant data have been found on the Web sites, wherein each URL address links a web page comprising the relevant data;
creating sub-commands based on the URL addresses for downloading the web pages by analyzing the list of URL addresses;
converting formats of the sub-commands into the extensible markup language format; and
executing the sub-commands to download the Web pages comprising the relevant data according to the URL addresses.

10. The method as claimed in claim 9, further comprising the step of deleting the commands that have been executed from the command queue.

11. The method as claimed in claim 9, further comprising the steps of:
executing the commands in the command queue to search the relevant data in a database;
determining whether any relevant data have been found in the database; and
returning a list of database locations of the relevant data if the relevant data have been found in the database.

12. The method as claimed in claim 9, wherein the creating step comprises the step of creating a queue handle for the command queue.

13. The method as claimed in claim 9, wherein the attributes of the commands decide orders of the commands in the command queue.
